(19) United States
(12) Patent Application Publication
(10) Pub. No.: US 2012/0312926 A1
(43) Pub. Date: Dec. 13, 2012

(54) Cargo Deck, Cargo Loading System and Method for Loading/Unloading a Cargo Hold

(75) Inventors: Richard Holzner, Stephanskirchen (DE); Thomas Huber, Schliersee (DE)

(73) Assignee: TELAIR INTERNATIONAL GMBH, Miesbach (DE)

(21) Appl. No.: 13/490,958

(22) Filed: Jun. 7, 2012

(30) Foreign Application Priority Data
Jun. 10, 2011 (DE) 102011051007.9

(51) Int. Cl. B64C 1/22

(52) U.S. Cl. 244/137.1

(57) ABSTRACT

The object according to the invention, is to create a cargo deck which enables freight items to be loaded and unloaded quickly and efficiently. This object is achieved by a cargo deck which comprises:
a first group (G1) of freight conveying devices (100, 110, . . . , 190) for conveying freight items (30) at a first conveying speed (v1) and
a second group (G2) of freight conveying devices (200, 210, . . . , 240) for conveying freight items (30) at a second conveying speed (v2), characterised in that the second conveying speed (v2) differs significantly from the first conveying speed (v1), in particular by an amount of at least 10%, in particular of at least 20%, in particular of at least 50% of the first conveying speed (v1).

The invention relates to a cargo deck, a cargo loading system and a method for loading/unloading a cargo hold.

Modern aircraft have extraordinarily large cargo holds with a correspondingly large cargo deck that are loaded with freight items, in particular freight containers and freight pallets. Standardised freight containers or freight pallets are normally used. However, it is not infrequent that the load extends beyond these freight containers or freight pallets.

It is a general requirement for unloading processes to take place as quickly as possible. Longer loading/unloading times mean increased costs for the operator.

It is well-known to use cargo loading systems for efficient loading and unloading of the cargo hold or cargo deck. They usually include a control computer and a plurality of actuators and sensors which are disposed inside the cargo hold, in particular on the cargo deck. Thus the cargo deck is provided, for example, with a plurality of freight conveying devices which make it possible to transport the freight items efficiently on the cargo deck. Functional elements, e.g. roller elements, guide and anchoring elements, are additionally provided. The freight conveying devices may include sensors which render it possible to identify the presence of a freight item. The control computer receives sensor signals from the sensors and acts on the freight conveying devices in such a manner that the freight items are set down at a predetermined position on the cargo deck or are unloaded as quickly as possible. A corresponding cargo loading system is known from EP 1 346 911 A1. During the loading and unloading of freight items, it is sometimes necessary for them to be rotated in a loading/unloading area close to the aircraft's doors. This loading and unloading area is frequently also used for aligning the freight items. Therefore this area is equipped with a higher density of freight conveying devices.

Based upon this prior art, it is an object of the present invention to provide a cargo deck, a cargo loading system and a method for loading/unloading a cargo hold which ensures a better loading and unloading process. In particular, the intention is to reduce the time necessary for loading and unloading freight items. The loading and unloading process is preferably fully automated or at least partially automated.

This object is achieved according to the invention by the cargo deck according to the present claim 1.

In particular, the object is achieved by a cargo deck which comprises:

a first group of freight conveying devices for conveying freight items at a first conveying speed and

a second group of freight conveying devices for conveying freight items at a second conveying speed.

The cargo deck is characterised in that the second conveying speed differs significantly from the first conveying speed, in particular by an amount of at least 10%, in particular of at least 20%, in particular of at least 50% of the first conveying speed.

An essential concept of the present invention is therefore that of operating freight conveying devices at different speeds in different places. It is possible by this means to contrive that the freight items are moved at different speeds in different areas during the loading and unloading process. Thus, the cargo deck according to the invention may be configured, for example, in such a manner that the freight items are conveyed at a higher speed in uncritical areas and at lower speeds in critical areas (e.g. in the cargo deck's loading and unloading area). Since modern aircraft are very long, the loading time can be massively shortened by the invention.

The freight conveying devices may include uncontrolled motors which are preferably designed to run at a constant speed.

Theoretically, it would be possible to control the speed of the freight conveying devices and therefore to individually control the conveying speeds as required. This, however, requires a massive control effort. In addition, speed-controlled motors lead to considerable electromagnetic compatibility problems. In this respect, uncontrolled motors are to be preferred. Moreover, the use of uncontrolled motors leads to a significant increase in the trouble-free running time of the motors. Malfunctions in the electronics or mechanics occur significantly less frequently. In addition, such freight conveying devices are suitable for use in the sometimes very harsh environment on a cargo deck.

The freight conveying devices of the first group may each include a gear unit with a transmission ratio which is higher than that of the gear unit of the freight conveying devices from the second group. It is also possible to achieve the different conveying speeds by using gear units which differ from each other and which have different transmission ratios. Preferably, the freight conveying devices may be essentially of identical design while merely the gear units within the first group or within the second group differ depending on the use of each freight conveying device.

The first group of freight conveying devices may be arranged in a loading and/or unloading area of the cargo deck and/or the second group in conveying paths of the cargo deck.

As already explained, the freight items are aligned and/or rotated in the loading/unloading area of the cargo deck. In this respect, it is advantageous if the freight items are conveyed at a slower conveying speed in this area. As soon as the freight items are inside the conveying paths, they can be transported at the second higher conveying speed. Preferably, the freight conveying devices of the second group are essentially aligned in such a manner that they convey the freight items in a longitudinal direction of the aircraft. The freight conveying devices of the second group may be arranged and configured in such a manner that they convey the freight items in a transverse direction of the aircraft. Preferably, the freight conveying devices of the first group can be pivoted in such a way that they can propel the freight items in different directions. In one embodiment example, the freight conveying devices of the first group are disposed on rotating plates which enable said devices to be pivoted. Corresponding freight conveying devices may be gathered, for example, from the patent application having the number DE 10 2011 000 743.

In addition, the object referred to is achieved by a cargo loading system having a cargo deck such as has already been described.

The cargo loading system may be in communicative connection with the freight conveying devices to activate and deactivate said freight conveying devices in order to load and/or unload a first freight item, wherein the cargo loading system has a position determination device for capturing the position of a least one second freight item, wherein the control device for this is configured, depending on the specific position of the at least one second freight item, to activate a selection of freight conveying devices from the second group in order to position the first freight item next to the second freight item.

Thus, the cargo loading system can have a position determination device which makes it possible to determine the position of the freight items already loaded and still to be loaded. In this respect, it is possible to specifically select some of the freight conveying devices from the second group in order to specifically position a second freight item still to be loaded. This selection may be made in such a way that only the freight conveying devices which maintain a sufficient distance to the freight items already positioned are activated. In this respect, a collision is prevented between freight items with a possibly high second freight conveying speed. Regardless of the position of the other freight items, when selecting the conveying devices from the second group, the control device can take into account limitations of the cargo deck, for example latches or side walls.

In one embodiment example, the cargo loading system has a dimension capturing device for at least partially capturing the dimensions of the freight items, wherein the control device for this is configured, depending on the dimensions captured, to carry out the selection of freight conveying devices, in particular to take into account interference allowances of the freight items when positioning the first freight item. It is possible for the control device to make assumptions regarding the dimensions of the freight items in order to make an appropriate selection of the freight conveying devices from the second group and to prevent collisions. Preferably, however, there is a dimension capturing device which provides specific details regarding the dimensions of the individual containers. Preferably, these details can also take into account a possible interference allowance.

The dimension capturing device may be a data reading device for capturing data assigned to the freight items, in particular for capturing RFID tags arranged on the freight items. Therefore the freight items are preferably equipped with a data storage device which enables information relating to the relevant freight item to be read out. This information may contain details about the dimensions and/or interference allowances. Alternatively, it would of course also be possible to measure the dimensions of the freight item on entering the cargo hold.

Moreover, the object referred to at the outset may be achieved by a method for loading and/or unloading a cargo hold of an aircraft wherein the method includes the following steps:

Alignment of at least a first freight item by means of a first group of freight conveying devices which propel the freight item at a first conveying speed;

Conveying of the freight item along a longitudinal direction of the aircraft by means of the second group of freight conveying devices which propel the freight item at a second conveying speed;

characterised in that the second conveying speed differs significantly from the first conveying speed, in particular by an amount of at least 10%, in particular of at least 20%, in particular of at least 50% of the first conveying speed.

The advantages which have already been explained in connection with the devices according to the invention also emerge for this method.

The method may additionally include the following steps:

Determination of a position of a second freight item inside the cargo hold by means of a position determination device;

Selection and activation of freight conveying devices from the second group depending on the position of the second freight item in order to position the first freight item next to the second freight item.

In addition, deceleration of the first freight item may take place depending on the position of the second freight item and/or a position of the first freight item. This deceleration may essentially be brought about by only activating a selection of the freight conveying devices from the second group such that when the first freight item reaches a certain position, it is no longer conveyed by the selected freight conveying device and therefore inevitably slows down. Alternatively, active deceleration of the freight item may take place, wherein at least a portion of the second group of freight conveying devices is specifically deactivated during the conveyance of the first freight item in order to halt said freight item. After halting of the freight item, the freight conveying devices may be re-activated in order to park the second freight item precisely on the specified position. For example, the second freight item can thus be (completely) halted just in front of the first freight item and can then be accelerated again until it is positioned more or less directly next to the first freight item. Alternatively, the first freight item can be halted prior to entering in latches provided for the purpose, then accelerated again and thus parked in position. The method according to the invention and the correspondingly configured control device make use here of the fact that the freight items have a significant mass and in this respect are accelerated with a certain inertia such that striking another freight item or a latch—still in the acceleration phase—takes place at low speed and with low force.

The freight conveying devices from the second group may be configured to propel the freight items at the second conveying speed which is greater than 15 metres per minute, in particular greater than 25 metres per minute.

Preferably, the freight conveying devices from the second group thus propel the freight item at a significantly higher speed than those from the first group.

The first freight conveying speed may be lower than the second freight conveying speed, in particular lower than 25 metres per minute, preferably lower than 15 metres per minute.

Further advantageous embodiments emerge from the dependent claims.

The invention is described below with reference to several embodiment examples which will be explained in more detail with reference to drawings.

The figures show:

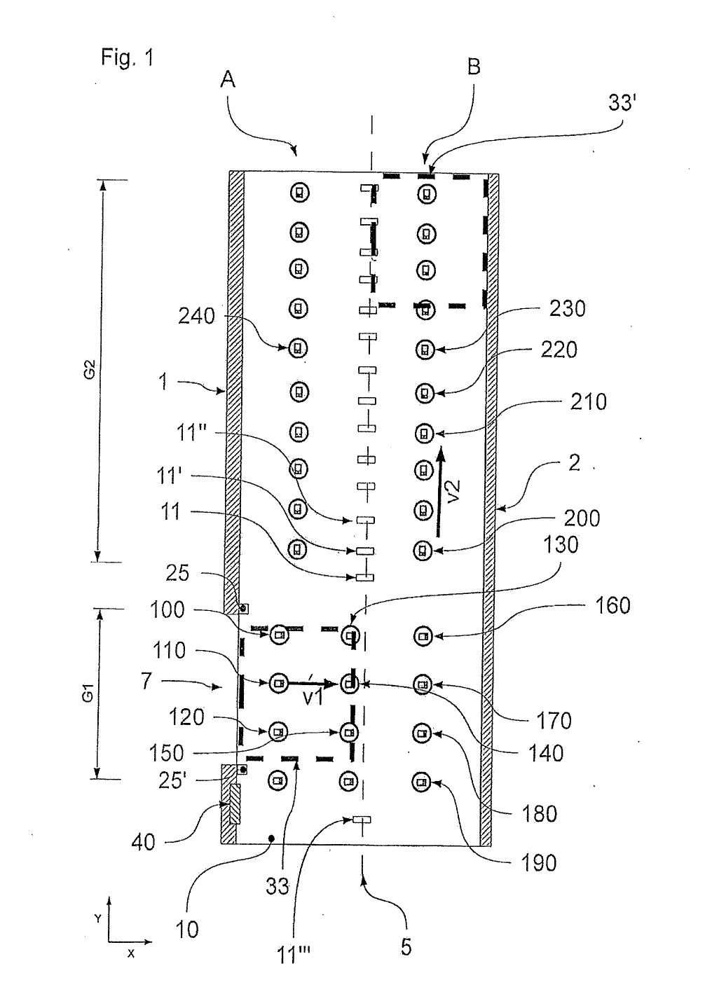

FIG. 1 a schematic illustration of the cargo deck having a plurality of freight conveying devices;

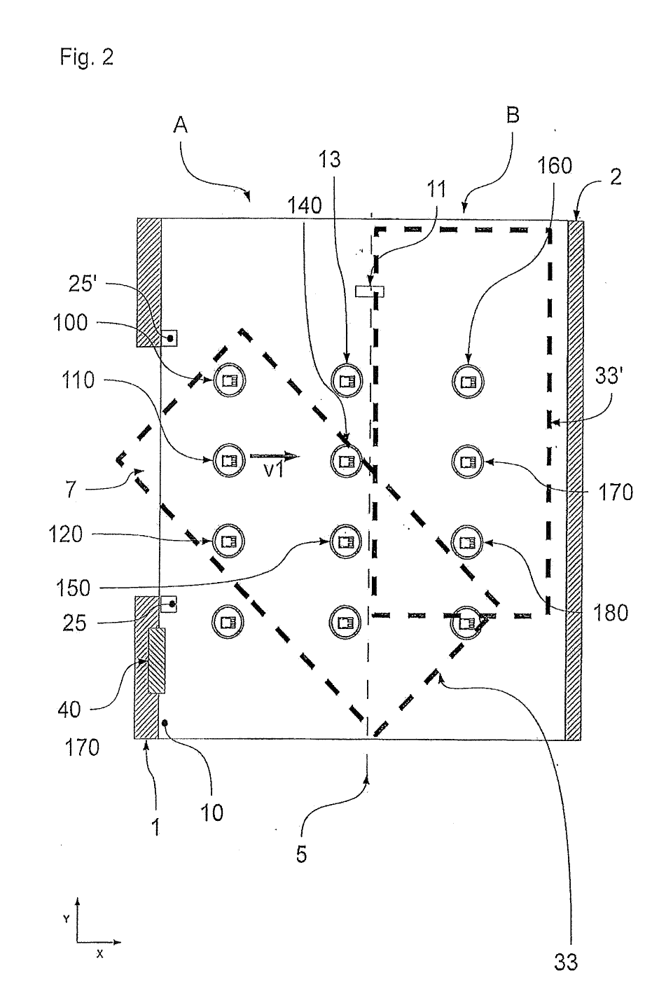

FIG. 2 a detailed view of the cargo deck from FIG. 1;

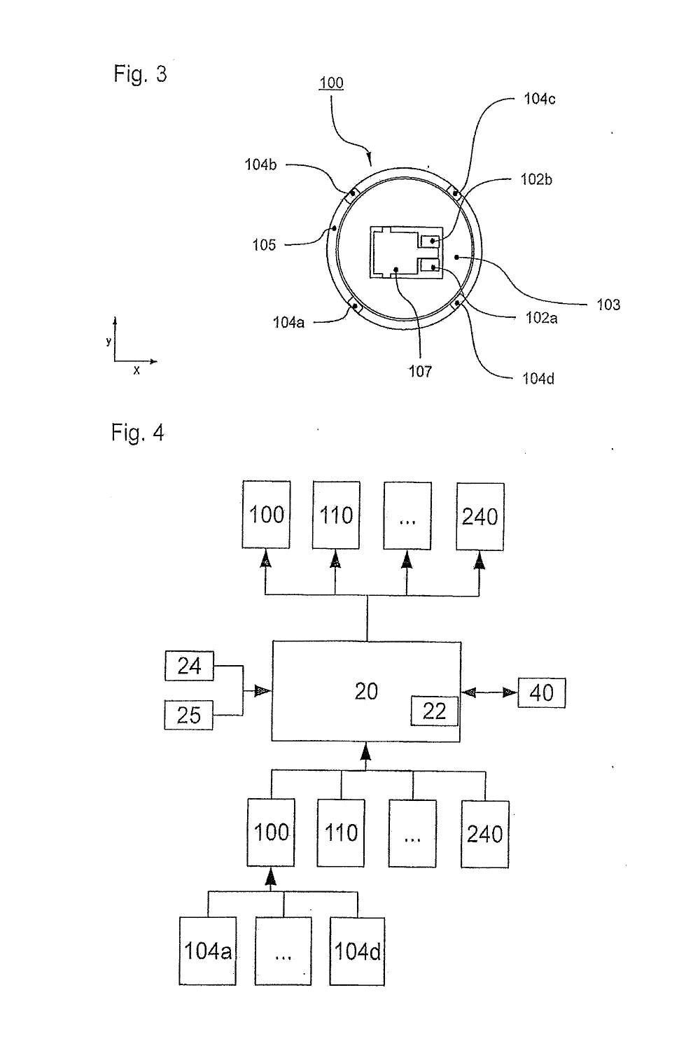

FIG. 3 a detailed view of the freight conveying device from FIGS. 1 and 2;

FIG. 4 a schematic illustration of the control computer with sensors and actuators;

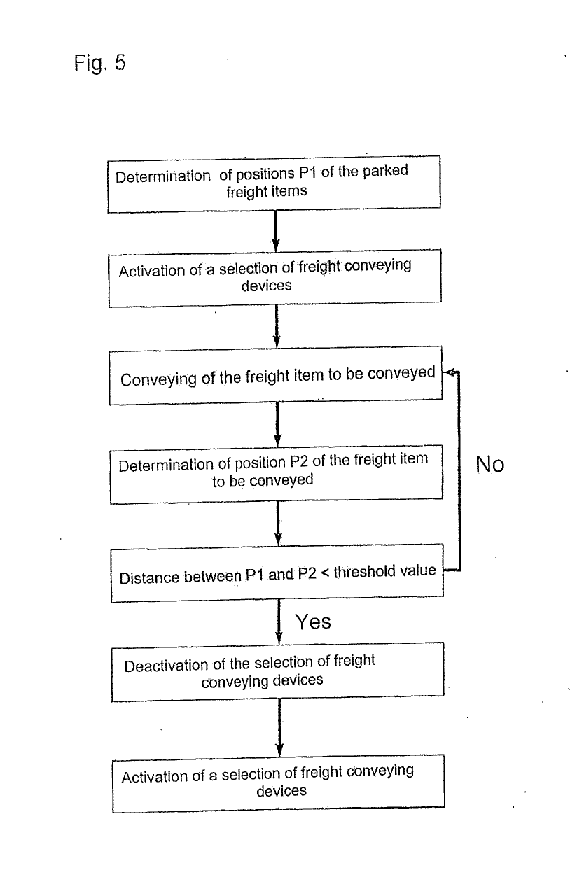

FIG. 5 a flow diagram of a control strategy implemented by the control computer; and

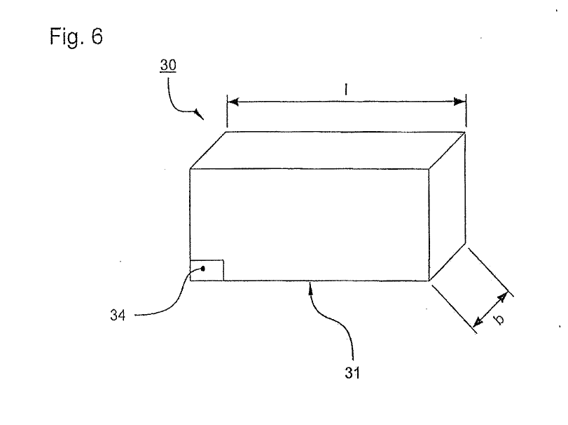

FIG. 6 a schematic illustration of a freight container.

In the following description, the same reference numerals are used for identical parts and parts acting in an identical manner.

FIG. 1 shows a schematic illustration of a cargo deck 10 of an aircraft, wherein cargo deck 10 is limited by a first side wall 1 and a second side wall 2. First side wall 1 has a door opening 7 through which freight items, in particular freight containers 30 (cf. FIG. 6) can be moved into the aircraft's cargo hold. Cargo deck 10 is equipped with functional elements essentially symmetrical to central plane 5 running centrally along the aircraft's longitudinal direction or Y direction. Arranged along the aircraft's Y direction on this central plane 5 are central latches 11, 11′, 11″, 11′″ which define a first cargo loading path A and a second cargo loading path B. First cargo loading path A is located on the side of central plane 5 facing toward door opening 7. Cargo deck 10 is equipped with a plurality of freight conveying devices 100, 110, . . . , 240 which are suitable for conveying freight containers 30 on cargo deck 10.

FIG. 6 shows a cuboid freight container 30 having a freight container length 1 and a freight container width b. A freight container base 31 of freight container 30 is essentially rectangular. The result is freight base outlines 33, 33′, such as are shown for example in FIGS. 1 and 2. Freight container 30 has an RFID tag 34 which stores data relating to freight container 30. For example, information regarding the dimensions of freight container 30, such as freight container length 1 and freight container width b, may be stored inside RFID tag 34.

According to the invention, a distinction is drawn in the case of freight conveying devices 100, 110, . . . , 240 of cargo deck 10 between a first group G1 and a second group G2. First group G1 of freight conveying devices 100, 110, . . . , 190 is located in the loading and unloading area of cargo deck 10 level with door opening 7. This first group G1 of freight conveying devices 100, 110, . . . , 190 is arranged and configured in such a manner that associated freight conveying devices 100, 110, . . . , 190 can appropriately align, if necessary rotate, freight containers 30. Freight conveying devices 200, 210, . . . , 240 of second group G2 are located in an region outside the loading/unloading area. In the embodiment example shown, they are arranged alternately to central latches 11, 11′, 11″, 11′″ in cargo loading paths A, B.

Freight conveying devices 100, 110, . . . , 240 are in communicative connection with the control computer 20 (FIG. 4) which can activate and deactivate them. In the embodiment example, freight conveying devices 100, 110, . . . , 240 are configured in such a manner that in an activated state they propel a freight item (e.g. freight container 30) which overlaps freight conveying devices 100, 110, . . . , 240 at a freight conveying speed v1 or v2. If one considers FIG. 1, for example, and assumes that freight container 30 takes up the position which has freight base outline 33 of FIG. 1, then in an activated state freight conveying devices 100, 110, 120, 130, 140, 150 would propel freight container 30.

Freight conveying devices 100, 110 are configured to propel freight items at a constant speed, wherein first group G1 of freight conveying devices 100, 110, . . . , 190 propel the freight items at first freight conveying speed v1 which is significantly lower than second freight conveying speed v2 of second group G2. In the embodiment example described, first freight conveying speed v1 of first group G1 is approximately equal to 14 metres per minute and second freight conveying speed v2 of second group G2 is approximately equal to 26 metres per minute. In this respect, it is possible to move freight container 30 into the aircraft's cargo hold and align it at a significantly slower first freight conveying speed v1. As soon as freight container 30 has been propelled by second group G2 of freight conveying devices 200, 210, . . . , 240, the speed of freight container 30 increases since freight conveying speed v2 is significantly higher. Due to this configuration of the cargo deck, it is possible to decrease the loading time considerably because significantly higher speeds can be achieved in non-critical areas, e.g. when conveying the freight items in the longitudinal direction inside cargo conveying paths A, B.

These different speeds are necessary because fast conveying in the loading/unloading area may lead to rapid wear of cargo deck 10, wear of the aircraft in general and also damage to the load and injury to staff FIG. 2 shows schematically how correspondingly larger freight container 30 is moved in the transverse direction (X direction) through door opening 7, is rotated within the loading and unloading area (cf. freight base outline 33) and ultimately aligned with second cargo loading path B (cf. freight base outline 33′) in order to be conveyed in the longitudinal direction in this second cargo loading path B.

In order to ensure rotation of freight container 30, freight conveying devices 100, 110, 120, . . . , 190 have a rotating plate 103. FIG. 3 shows by way of example the exact configuration of freight conveying device 100. Freight conveying device 100 has an annular frame 105 and a circular rotating plate 103 arranged in frame 105. Rotating plate 103 is rotatably supported within frame 105 in such a manner that it can be rotated about a rotational axis in the X-Y plane. Freight conveying device 100 has corresponding actuators and sensors such that rotating plate 103 can be aligned arbitrarily within frame 105. The sensors provide information about the alignment of rotating plate 103 within frame 105. Rotating plate 103 accommodates a roller drive unit 107 which actuates drive rollers 102a, 102b. Drive rollers 102a, 102b are configured to propel freight items in a direction transverse to the rotary axis of drive rollers 102a, 102b essentially within the X-Y plane. FIG. 3 shows freight conveying device 100 in an orientation in which it can propel the freight items in the aircraft's transverse direction (X direction). It should be obvious for the person skilled in the art working in this field that the freight items can be propelled in the opposite direction by actuating drive rollers 102a, 102b in an opposing direction.

A preferred embodiment of freight conveying device 100 additionally includes four sensor devices 104a, 104b, 104c, 104d which are arranged on frame 105. In this respect, the orientation of rotating plate 103 does not affect the position of sensor devices 104a, 104b, 104c, 104d. Sensor devices 104a, 104b, 104c, 104d are preferably each arranged on the opposite side of frame 105. Thus first sensor device 104a is located in the 45° region of freight conveying device 100, second sensor device 104b in the 135° region, third sensor device 104c in the 225° region and fourth sensor device 104d in the 315° region. Sensor devices 104a, 104b, 104c, 104d are light sensors which comprise light emitting diodes and photodiodes such that sensor devices 104a, 104b, 104c, 104d are suitable for detecting the presence of a freight item immediately above sensor devices 104a, 104b, 104c, 104d. Moreover, these sensor devices 104a, 104b, 104c, 104d are suitable to identify partial or complete covering of freight conveying device 100 by a freight item.

Theoretically, it would be possible by means of four sensor devices 104a, 104b, 104c, 104d to identify whether freight container 30 is arriving in the transverse direction to freight conveying device 100. In this respect, it is possible to identify a direction of motion of freight container 30 and to take this into account.

In the embodiment example described, at least every freight conveying device 100, 110, . . . , 190 of group GI and every freight conveying device 200, 210, . . . , 240 of second group G2 has corresponding sensor devices 104a, 104b, 104c, 104d. These are in communicative connection with control computer 20.

Based on this configuration of cargo deck 10, it is possible for control computer 20 to position freight container 30 automatically or at least with computer assistance on a specified (parking) position on cargo deck 10 without freight container 30 itself or other freight containers 30 that are already parked on cargo deck 10 or functional elements which are arranged on the cargo deck being damaged. Control computer 20 implements a position determination device 22 for this purpose (FIG. 4). This determines a first position P1 of the freight items already parked (cf. FIG. 5). Thereafter it activates a selection of freight conveying devices 200, 210, . . . , 240 of group G2 in order to position the freight item to be conveyed on the specified position. Activated freight conveying devices 200, 210, . . . , 240 of second group G2, convey the freight item. During the conveying procedure, control computer 20 continuously determines a second position P2 of the freight item to be conveyed and deactivates the selection of freight conveying devices 200, 210, 120, . . . , 240 of group G2 as soon as the distance between first position P1 and second position P2 is below a specified threshold value (e.g. 10 cm). As the freight item to be conveyed is no longer propelled by freight conveying devices 200, 210, . . . , 240, it halts. Control computer 20 captures, e.g. by means of sensors, the standstill of the freight item to be conveyed. Alternatively, control computer 20 may wait a specified time in order to ensure that the freight item to be conveyed has come to a complete standstill. Thereafter, the selection of freight conveying devices 200, 210, . . . , 240 of second group G2 is reactivated such that the freight item to be conveyed is finally parked in the parking or target position. The last-mentioned steps of deactivation and activation have the advantage that the freight item is only accelerated slowly because of its mass with the result that the freight item is parked at only a low speed despite high second freight conveying speed v2. This protects existing functional elements and freight items already parked.

During the loading process, for example, a first freight container 30 may be aligned with second conveying path/freight loading path B and a second freight container 30 may be located inside second freight loading path B at the position specified by freight base outline 33′. In this case, control computer 20 can activate freight conveying devices 200 to 230 and the freight conveying devices located between them until second freight container 30 is in a position in which it partially covers freight conveying device 230. Sensor devices 104a, 104b, 104c, 104d of freight conveying device 230 can detect this position. In this case, control computer 20 halts second freight container 30 by deactivating freight conveying devices 100, 110, . . . , 240, in particular freight conveying devices 210, 220, 230. Thereafter, these freight conveying devices 210, 220, 230 are reactivated in such a manner that although they operate at second freight conveying device v2, the freight container has a significantly lower speed due to inertia. In this respect, the impact with freight container 30 already positioned is significantly less than it would be at full speed.

For the embodiment example described, it is not necessary for the control computer to know the dimensions of freight container 30. An appropriate control algorithm can be implemented merely on the basis of the degree of overlap of freight conveying devices 100, 110, . . . , 240. In a second embodiment example, however, control computer 20 captures RFID tag 34 on freight container 30 when freight container 30 enters the cargo hold and determines its exact dimensions. Position determination device 22 may then be configured in such a manner that it always determines the exact position of freight container 30 based on sensor devices 104a, 104b, 104c, 104d which are distributed over entire cargo deck 10 and based on the movement pattern of freight container 30. In so doing, the speed with which a freight container 30 moves in a specific direction can also be taken into account. Control computer 20 can also determine the exact position of freight containers already parked on cargo deck 10. In this respect, it is no problem for control computer 20 to calculate exact distances between individual freight containers 30. In this embodiment example, control computer 20 can stop freight container 30 to be parked precisely when the distance between freight container 30 to be parked and another freight container is less than the specified threshold value or if the freight container to be parked has been moved close to an end latch. After halting freight container 30 to be parked, there is renewed acceleration as has already been described such that freight container 30 takes up its final position.

Theoretically, it would also be possible to enter corresponding dimensions of freight container 30 manually. An appropriate input device 24 could be provided for this. The cargo loading system according to the invention also preferably includes a display 40 which enables the user to track the loading process precisely. RFID sensor devices 25, 25′ are arranged alternately on door opening 7 for capturing RFID tag 34.

In the embodiment example described above, all freight conveying devices 100, 110, . . . , 240 have rotating plates 103. For the person skilled in the art working in this field, it should be obvious that freight conveying devices 200, . . . , 240 of second group G2 do not need any rotating plates 103 since they merely convey freight container 30 in the aircraft's longitudinal direction, in the Y direction. In this respect, it is conceivable to execute these freight conveying devices 200, 210, . . . , 240 in such a manner that they have no rotating plates 103.

In the embodiment examples referred to previously, control computer 20 refers back predominantly to the sensor signals which are provided by sensor devices 104a, 104b, 104c, 104d. It is, however, possible to arrange further sensors on the cargo deck. For example, approximation sensors may be provided on latches in order to prevent freight container 30 from running into these latches at high speed. Here too, there may be halting and renewed acceleration of freight containers 30.

Freight conveying devices 100, 110, . . . , 240 described are configured only to actuate drive rollers 102a, 102b when they are activated and if a freight item (e.g. freight container 30) is located directly over them. However, some or all freight conveying devices 100, 110, . . . , 240 may also be configured, in the activated state, to actuate drive rollers 102a, 100b regardless of the presence of a freight item.

### LIST OF REFERENCE NUMBERS

1, 2 Side walls
5 Central plane
7 Door opening
10 Cargo deck
11, 11′, 11″, 11′″ Central latch
20 Control computer
22 Position determination device
24 Input device
25, 25′ RFID sensor device
30 Freight container
31 Freight base
33, 33′ Freight base outlines
34 RFID tag
40 Display
100, 110, . . . , 190 Freight conveying devices of the first group
200, 210, . . . , 240 Freight conveying devices of the second group
102a, 102b Drive rollers
103 Rotating plate
104a, 104b, 104c, 104d Sensor devices
105 Frame
107 Roller drive unit
X, Y X or Y direction
A Cargo loading path A
B Cargo loading path B
G1 First group
G2 Second group
b Freight container width
1 Freight container length
v1, v2 Freight conveying speed

1. A cargo deck comprising:
a first group of freight conveying devices for conveying freight items at a first conveying speed and
a second group of freight conveying devices for conveying freight items at a second conveying speed, characterised in that the second conveying speed differs significantly from the first conveying speed, in particular by an amount of at least 10%, in particular of at least 20%, in particular of at least 50% of the first conveying speed.

2. The cargo deck according to claim 1, characterised in that the freight conveying devices include uncontrolled motors which are preferably designed to run at a constant speed.

3. The cargo deck according to claim 1, characterised in that the freight conveying devices of the first group each include a gear unit with a transmission ratio which is higher than that of the gear unit of the freight conveying devices of the second group.

4. The cargo deck according to claim 1, characterised in that the first group of freight conveying devices is arranged in a loading and/or unloading area of the cargo deck and/or the second group in conveying paths of the cargo deck.

5. A cargo loading system having a cargo deck according to claim 1 and a control device which is in communicative connection with the freight conveying devices for activation and deactivation of the freight conveying devices in order to load and/or unload a first freight item, wherein the cargo loading system has a position determination device for capturing the position of at least one second freight item, wherein the control device is configured, depending on the specific position of the at least one second freight item, to activate a selection of freight conveying devices from the second group in order to position the first freight item next to the second freight item.

6. The cargo loading system according to claim 5, characterised by a dimension capturing device for at least partially capturing the dimensions of the freight items, wherein the control device for this is configured, depending on the dimensions captured, to carry out the selection of freight conveying devices, in particular to take into account interference allowances of the freight items when positioning the first freight item.

7. The cargo loading system according to claim 5, characterised in that the dimension capturing device may be a data reading device for capturing data assigned to the freight items, in particular for capturing RFID tags arranged on the freight items.

8. A method for loading and/or unloading a cargo hold of an aircraft, comprising the steps:
Alignment of at least a first freight item by means of a first group of freight conveying devices which propel the freight item at a first conveying speed;
Conveying of the freight item along a longitudinal direction of the aircraft by means of a second group of freight conveying devices which propel the freight item at a second conveying speed;
characterised in that the second conveying speed differs significantly from the first conveying speed, in particular by an amount of at least 10%, in particular of at least 20%, in particular of at least 50% of the first conveying speed.

9. The method for loading a cargo hold according to claim 8, characterised by
a determination of a position of a second freight item inside the cargo hold by means of a position determination device;
a selection and activation of freight conveying devices from the second group depending on the position of the second freight item in order to position the first freight item next to the second freight item.

10. The method according to claim 8, characterised by a deceleration of the first freight item depending on the position of the second freight item and/or a position of the first freight item.

11. The method according to claim 10, characterised by an acceleration of the first freight item after the deceleration based on at least one of the freight conveying devices from the second group in order to park the first freight item in a specified target position.

12. The method according to claim 10, characterised by a determination of one dimension of at least the first freight item, wherein the deceleration takes place depending on the dimension determined.

13. The method according to claim 12, characterised in that the determination of the dimension of at least the first freight item includes a reading out of data which is stored in a memory on and/or in the freight item, in particular on a passive transponder.

14. The cargo deck according to claim 1, characterised in that the freight conveying devices from the second group are configured to propel the freight items at the second conveying speed which is greater than 15 metres per minute, in particular greater than 25 metres per minute.

15. The cargo deck according to claim 1, characterised in that the first freight conveying speed is lower than the second freight conveying speed, in particular lower than 25 metres per minute, preferably lower than 15 metres per minute.

16. The method of claim 8, characterised in that the freight conveying devices from the second group are configured to propel the freight items at the second conveying speed which is greater than 15 metres per minute, in particular greater than 25 metres per minute.

17. The method of claim 8, characterised in that the first freight conveying speed is lower than the second freight conveying speed, in particular lower than 25 metres per minute, preferably lower than 15 metres per minute.
